(19) United States
(12) Patent Application Publication
(10) Pub. No.: US 2026/0258653 A1
(43) Pub. Date: Sep. 3, 2026

(54) CONSTRUCTION BOARD ASSEMBLY WITH HIGH FLAME, TEMPERATURE, AND ACOUSTIC RESISTANT CAPABILITIES

(71) Applicants: Bobby Todd Wright, Orlando, FL (US); Todd Stephen Ellis, Orlando, FL (US)

(72) Inventors: Bobby Todd Wright, Orlando, FL (US); Todd Stephen Ellis, Orlando, FL (US)

(21) Appl. No.: 19/555,372

(22) Filed: Mar. 3, 2026

Related U.S. Application Data
(60) Provisional application No. 63/834,188, filed on Mar. 3, 2025.

(51) Int. Cl. E04B 1/86; B32B 5/02; B32B 7/12; B32B 9/04; E04B 1/84

(52) U.S. Cl. CPC E04B 1/86; B32B 5/02; B32B 7/12; B32B 9/047; B32B 2250/02; B32B 2262/062; B32B 2305/70; B32B 2307/102; B32B 2307/72; E04B 2001/8461

(57) ABSTRACT

A construction board assembly includes a magnesium oxide construction board and an acoustic textile board bonded together with an adhesive. The assembly is transportable as a single unit and can be attached to structural framing members with either side facing the members. The construction board and acoustic textile board provide a balance of structural strength and sound insulation. The assembly can be used in various building applications, including walls, floors, and ceilings, and can receive finish materials or provide a finished surface. The assembly simplifies construction and provides improved performance characteristics, making it suitable for residential, commercial, and industrial building projects.

### CROSS-REFERENCE TO RELATED APPLICATION

This application claims priority to U.S. Provisional Patent Application No. 63/834,188, filed on March 3, 2025, and titled BUILDING BOARD SYSTEM WITH HIGH FLAME, TEMPERATURE, AND ACOUSTIC RESISTANT CAPABILITIES, the entire content and disclosure of which is incorporated by reference in its entirety.

### FIELD

The field of the disclosure relates generally to construction board assemblies and, more particularly, to a construction board assembly including an acoustic textile board providing high flame, temperature, and acoustic resistant capabilities.

### BACKGROUND

Materials, such as gypsum board, cement board, and plywood, have been widely used for building walls, floors, and ceilings, but often lack a combination of desired performance characteristics, such as combining strength with acoustic insulation. For example, they tend to be weak in soundproofing and ineffective in fire resistance. To meet performance or code requirements for at least some applications, additional layers or treatment with specialized materials are often required to enhance these features, increasing material costs and labor requirements.

Therefore, there is a need for a construction board assembly that combines enhanced soundproofing capabilities with other desired characteristics while remaining cost-effective and simple to install.

### BRIEF DESCRIPTION

In some aspects, a construction board assembly generally includes a construction board including magnesium oxide, an acoustic textile board, and an adhesive between the construction board and the acoustic textile board. The construction board includes a first face and a second face. The first face of the construction board defines a first side of the construction board assembly. The acoustic textile board includes a first face and a second face. The second face of the acoustic textile board defines a second side of the construction board assembly. The adhesive bonds the first face of the acoustic textile board to the second face of the construction board. The construction board assembly is transportable as a single unit and is configured to attach to structural framing members with the first side or the second side facing the structural framing members.

In some aspects, a method of assembling a construction board assembly includes providing a construction board including magnesium oxide and including a first face and a second face. The first face of the construction board defines a first side of the construction board assembly. The method also includes providing an acoustic textile board including a first face and a second face. The second face of the acoustic textile board defines a second side of the construction board assembly. The method further includes depositing an adhesive on the second face of the construction board or the first face of the acoustic textile board. The adhesive bonds the first face of the acoustic textile board to the second face of the construction board to form the construction board assembly.

In some aspects, a structure includes structural framing members and a construction board assembly attached to the structural framing members. The construction board assembly includes a construction board including magnesium oxide and including a first face and a second face; an acoustic textile board including a first face and a second face; and an adhesive between the construction board and the acoustic textile board. The adhesive bonds the first face of the acoustic textile board to the second face of the construction board. The first face of the construction board or the second face of the acoustic textile board is mounted to the structural framing members.

### BRIEF DESCRIPTION OF THE DRAWINGS

FIG. 1 is a perspective view of a construction board assembly.

FIG. 2 is a side view of the construction board assembly.

FIG. 3 is a partially exploded perspective view of the construction board assembly.

FIG. 4 is a flow diagram of a method of assembling the construction board assembly.

FIG. 5 is a perspective view of a structure which includes the construction board assembly.

FIG. 6 is an exploded perspective view of an example of a floor, including the construction board assembly.

FIG. 7 is an exploded perspective view of an example of a floor, including the construction board assembly in multiple locations.

FIG. 8 is an exploded perspective view of an example of a construction board assembly including adhesive deposited in a pattern.

FIG. 9 illustrates an exploded view of an example of an exterior wall, including the construction board assembly, with portions removed to illustrate interior components.

FIG. 10 illustrates an exploded view of an example of an interior wall, including the construction board assembly, with portions removed to illustrate interior components.

### DETAILED DESCRIPTION

This disclosure describes a construction board assembly that acts as a double-layered, acoustically isolated structural panel for interior floor, wall, and/or ceiling assemblies and reduces sound transmission and thermal bridging with a continuous insulative and acoustic layer. The construction board assembly provides structural capacity and fire resistance in a single laminated panel. For example, components of the construction board assembly work together to increase the building’s structural integrity, provide 1.5 to 2-hour fire resistance, protect against termites and other insects, and protect against water/air vapor intrusion. In addition, the construction board assembly is reversible and can receive direct-applied finish material.

Examples of the construction board assembly include magnesium oxide construction board combined with an acoustic textile board, resulting in a composite structure that achieves a desired balance of enhanced structural strength, improved soundproofing capabilities, flame and heat resistance, ease of use, and versatility in construction applications. The construction board assembly is particularly applicable in residential structures, such as multi-family dwellings, commercial buildings, and industrial building projects, where superior performance in fire resistance, sound deadening, and load-bearing capacity is required.

In some examples, components of the construction board assembly are joined using an adhesive, including, for example, an epoxy resin with silica or alumina filler additives. The adhesive, including the additives, is selected to provide high compressive and tensile strength. In addition, the additives improve acoustic properties by increasing density, which aids in sound dampening. The adhesive is resistant to heat and withstands temperatures up to 200°C (392°F) in standard grades and up to 300°C (572°F) in specialized formulations. The adhesive is resistant to moisture, UV exposure, and chemicals and enhances the durability of the construction board assembly in various conditions.

In examples, the construction board assembly is provided as a pre-bonded, 2-in-1 integrated unit specifically engineered to accelerate the construction process and reduce on-site labor, material waste, and logistics costs by consolidating multiple installation phases into a single step. By combining the construction board and acoustic textile board into a single, transportable, and installable unit, the assembly minimizes the complexity of managing separate material streams and reduces the physical footprint of materials stored on-site.

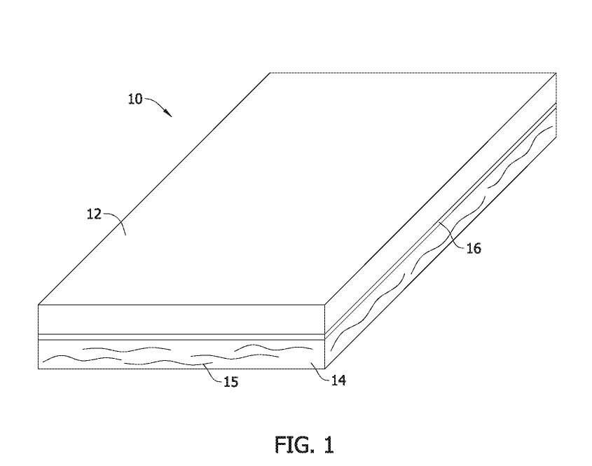

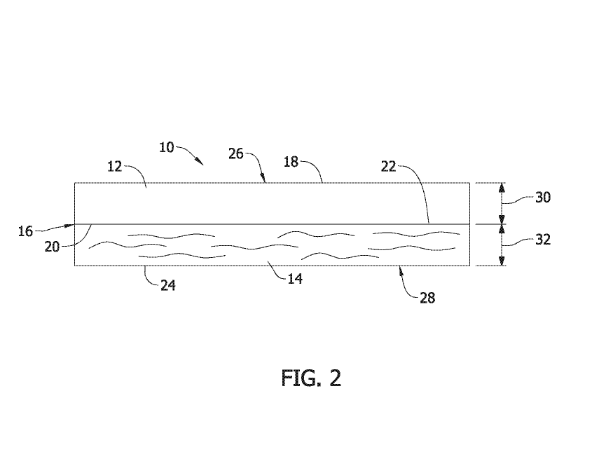

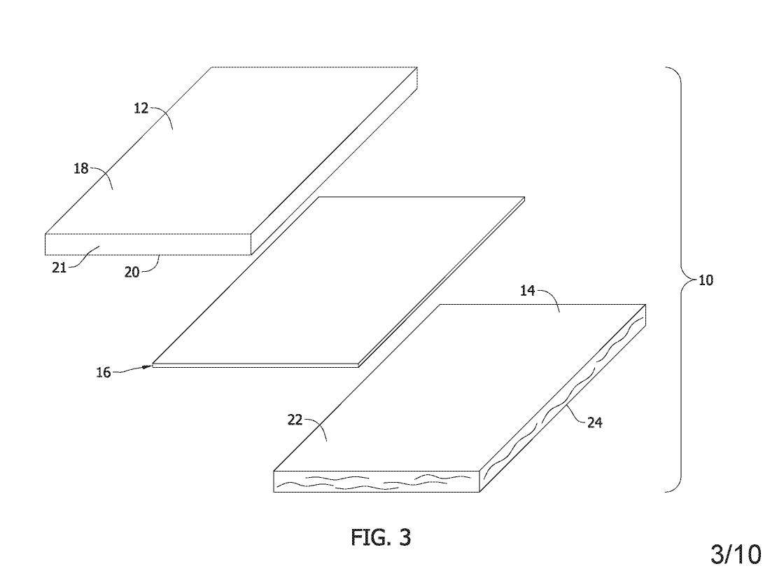

FIG. 1 illustrates a perspective view of a construction board assembly 10. FIG. 2 is a side view of the construction board assembly 10. FIG. 3 is a partially exploded perspective view of the construction board assembly 10. The construction board assembly 10 is modular and is configured to act as multiple components of a structure. For example, the construction board assembly 10 may be used as sheathing and has a structural load capacity to resist forces and provide structural support for a wall, floor, and/or a ceiling of a building. In addition, the construction board assembly 10 may be used as a finished surface for interior or exterior walls, ceilings, or floors.

The construction board assembly 10 generally includes a construction board 12, an acoustic textile board 14, and an adhesive 16. The construction board 12 and acoustic textile board 14 form opposite, outer layers of the construction board assembly 10, and the adhesive 16 is sandwiched between the construction board 12 and the acoustic textile board 14. The arrangement of the components of the construction board assembly 10 provides a continuous insulative layer while maintaining structural integrity and fire resistance.

The construction board 12 includes a material that provides improved performance, such as magnesium oxide (MgO). For example, magnesium oxide enhances structural integrity, provides a surface suitable for direct-applied finish material, and contributes to the ability of the construction board 12 to resist nail and screw pullout. Additionally, the magnesium oxide in the construction board 12 offers superior fire resistance to reduce the risk of fire spread, is resistant to pests and microorganisms, and is impermeable to moisture or vapor. In use, the construction board 12 with magnesium oxide has the strength to maintain the attachment of the construction board assembly 10 to the building structure and provide a surface to which fixtures and various types of finish material may be attached.

In the example, the construction board 12 is constructed as a single continuous and solid layer of the magnesium oxide. For example, the magnesium oxide of the construction board 12 has a density greater than 0.9 g/cm³ and is impermeable to moisture or vapor. The magnesium oxide is composed of inert, non-combustible materials. In some examples, the construction board 12 includes additional or different materials incorporated with or in place of the magnesium oxide. For example, the construction board 12 may include additives, such as silane, Iodopropynyl Butylcarbamate (IPBC), or borate.

The construction board 12 includes a first face 18, a second face 20, and lateral surfaces 21 extending between the first face 18 and the second face 20. The first face 18 and the second face 20 are each planar (i.e., lie in a single plane) and are parallel to each other. The lateral surfaces 21 are perpendicular to the first face 18 and the second face 20 and extend continuously on the perimeter of the first face 18 and the second face 20. In this example, the lateral surfaces 21 include four planar surfaces joined at right angles at corners of the construction board 12. As a result, the construction board 12 is a rectangular cuboid. The shape of the construction board 12 facilitates the construction board assembly 10 being modular and compatible with a broad range of construction applications. In addition, the shape of the construction board 12 facilitates the construction board 12 matching and being joined to the acoustic textile board 14.

In this example, the first face 18 and the second face 20 feature different surface finishes. The first face 18 is treated (e.g., sanded or otherwise treated) and is smooth to facilitate use as an exposed surface to receive and retain direct-applied finish materials. The second face 20 is specifically prepared (e.g., textured or chemically treated) to enhance adhesion with the adhesive 16. For example, the second face 20 has a rough or abrasive surface that provides a higher coefficient of friction than the first face 18. In other examples, the first face 18 and the second face 20 may have similar surface finishes.

In some examples, the lateral surfaces 21 of the construction board 12 are not planar and are shaped to provide different edge formats to facilitate installation of the construction board assembly 10. For example, the lateral surfaces 21 can be shaped to accommodate tongue and groove joints, butt joints, spline joints, lap joints, or any other joints facilitating overlap or abutment between boards and reducing gaps or seams. For example, the lateral surfaces 21 may include a recessed area and a protruding section (e.g., a step) that corresponds to a complementary feature on an adjacent board, enabling a secure and flush connection between the boards. The shapes of the lateral surfaces 21 facilitate the creation of a continuous and cohesive surface, reduce the risk of water or air intrusion, and enhance the overall performance of the construction board assembly 10.

The construction board 12 has a thickness 30 defined between the first face 18 and the second face 20. The thickness 30 may be in a range of 1/4 inch (6 millimeters (mm)) to 4/5 inch (20 mm), and/or the thickness 30 may be selected from standardized sizes including 1/8 inch (3.18 mm), 1/4 inch (6.35 mm), 3/8 inch (9.53 mm), 1/2 inch (12.7 mm), 5/8 inch (15.88 mm), 3/4 inch (19.05 mm), or 1 inch (25.4 mm). The thickness 30 is selected to provide a desired strength for the construction board 12 and/or for the construction board 12 to fit a specified application (e.g., a desired wall thickness).

The acoustic textile board 14 includes fibers 15 that form a textile layer and provide desired characteristics to the construction board assembly 10. In some examples, the acoustic textile board 14 is constructed of one layer of textile material having a uniform thickness and extending continuously throughout the construction board assembly 10. In other examples, the acoustic textile board 14 includes two or more layers that are joined together, and each layer may or may not have the same thickness, materials, and/or configurations as other layers.

In this example, the fibers 15 of the acoustic textile board 14 include recycled denim. Accordingly, the acoustic textile board 14 is constructed as a recycled acoustical fiber board. The acoustic textile board 14 is constructed to be low-cost, environmentally friendly, and provide improved performance because of the fibers 15 selected. Other fiber materials that can be used in the acoustic textile board 14 in addition to or in place of the recycled denim include, for example and without limitation, cotton, polyester, nylon, and/or natural fibers such as wool, hemp, and bamboo.

The fibers 15 have characteristics such as density and thickness that provide desired properties for the acoustic textile board 14. The density of the fibers 15 refers to the mass per unit volume of the fibers, which affects the acoustic properties of the acoustic textile board 14. A higher density generally results in increased sound absorption, particularly in the low-frequency range. The thickness of the fibers 15, measured in denier (a unit of measurement for the fineness of fibers), influences the flexibility and porosity of the acoustic textile board 14. The denier value represents the weight in grams of 9,000 meters of fiber, with lower denier values indicating finer fibers. A thickness of 1-10 denier corresponds to a fiber diameter range of approximately 10-100 microns, allowing for effective sound wave dissipation and acoustic insulation. For example, the fibers 15 of the acoustic textile board 14 may have a density in the range of 0.03-0.3 g/cm³ and a thickness of 1-10 denier. The combination of density and thickness of the fibers 15 enables the acoustic textile board 14 to provide sound absorption and insulation properties. In other examples, the fibers 15 may have other densities and/or thicknesses selected to provide a balance of properties for designated applications.

The fibers 15 may be joined together in any suitable manner to form the acoustic textile board 14. For example, the fibers 15 may be joined via a thermal bonding process, needle punching, chemical or resin bonding, ultrasonic welding, or combinations thereof. In some examples, the fibers 15 are joined to form a porous matrix, optionally including a binder material to provide structural integrity. The resulting interstitial channels between the joined fibers 15 are configured to dissipate sound energy through viscous friction as air molecules move through the acoustic textile board 14.

The construction of the acoustic textile board 14 facilitates customization of the properties of the construction board assembly 10. For example, the fibers 15 are selected and arranged for performance properties including at least one of acoustical properties, structural strength, fire resistance, thermal conductivity, moisture intrusion, air intrusion, or insect protection. For example, the acoustic impedance of the acoustic textile board 14 is tuned by selectively adjusting the density or thickness of the fibers 15 and/or porosity of the interstitial channels between the fibers 15. Increasing the density of the fiber matrix or increasing the thickness directly increases the acoustic resistance and facilitates targeted absorption of low-frequency sound waves (e.g., frequencies below 250 Hz) because the interstitial channels force sound waves to dissipate energy through viscous friction and thermal exchange with the fibers 15.

The acoustic textile board 14 has a first face 22 and a second face 24. The first face 22 and the second face 24 are each planar (i.e., lie in a single plane) across their entirety and are parallel to each other. In addition, the first face 22 and the second face 24 include a fibrous topography characterized by the stochastic arrangement of the fibers 15. For example, the first face 22 and the second face 24 include localized depressions or fusion points resulting from the joining process (e.g., needle-punching indentations, thermal bond sites, or ultrasonic weld points). The fibrous topography on the first face 22 and the second face 24 maintains the porosity of the acoustic textile board 14 and facilitates penetration of sound energy into the interstitial channels between the fibers 15 to be dampened by the acoustic textile board 14.

The acoustic textile board 14 has a thickness 32 defined between the first face 22 and the second face 24. The thickness 32 of the acoustic textile board 14 is configured to facilitate tuning the acoustic impedance of the fiber matrix. For example, increasing the thickness 32 increases the absorption of low-frequency sound waves. Also, the thickness 32 is selected to provide a desired structural rigidity for the construction board 12 and/or for the construction board 12 to fit a specified application (e.g., a desired floor thickness) while maintaining the desired performance requirements. For example, the thickness 32 may be at least 1/8” (3 mm). In this example, the thickness 32 is 1/4" (6 mm).

The adhesive 16 is positioned between the construction board 12 and the acoustic textile board 14. For example, the adhesive 16 bonds the first face 22 of the acoustic textile board 14 to the second face 20 of the construction board 12. The adhesive 16 forms a continuous and monolithic layer extending throughout the entire interface between the construction board 12 and the acoustic textile board 14. In other examples, the adhesive 16 is arranged in a discontinuous pattern (either random or ordered). For example, the adhesive 16 may be arranged in a pattern of repeating geometric shapes.

The adhesive 16 may include any material suitable to bond the construction board 12 to the acoustic textile board 14. For example, the adhesive 16 is a specialized structural, low-VOC (volatile organic compound) or VOC-free adhesive specifically formulated for the high-strength bonding of magnesium oxide surfaces to porous acoustic textile fibers. In some examples, the adhesive 16 is a polymeric adhesive. Examples of polymeric adhesives include one or more of a urethane adhesive (e.g., a one-part moisture-cure urethane), an epoxy resin, an acrylic adhesive, a cyanoacrylate, a silicone, a polyvinyl acetate (PVA), or an ethylene-vinyl acetate (EVA). In other examples, the adhesive 16 may comprise a non-polymeric adhesive, such as a modified silane (MS) polymer, a cementitious adhesive, or an inorganic adhesive like sodium silicate. The adhesive 16 may be deposited in a liquid, molten, or semi-solid form and subsequently set or cured to form a permanent bond between the construction board 12 and the acoustic textile board 14.

In this example, the adhesive 16 is non-reactant and compatible with the construction board 12 and the acoustic textile board 14. In addition, the adhesive 16 has a high glass transition temperature (Tg) for stability under thermal stress. For example, the adhesive 16 includes a non-flammable construction epoxy resin, one-part cure type such as a novolac-based epoxy which is a high-performance, multifunctional thermosetting resin that provides improved chemical, solvent, and thermal resistance compared to other epoxies. The novolac-based epoxy features a highly cross-linked molecular structure, providing low permeability and excellent adhesion for harsh, corrosive industrial environments. The adhesive 16 may be applied onto the first face 22 of the acoustic textile board 14 at approximately 8-10 g/sq. ft.

In addition, optionally, the adhesive 16 includes at least one additive selected to modify a property of the adhesive. For example, the adhesive 16 includes an additive (or additives) that affects the sound dampening qualities, thermal resistance, structural strength, fire resistance, pest or rodent resistance, and/or any other properties of the construction board assembly 10. Example additives include acoustic damping agents (e.g., silica, alumina, or microspheres), and fire-retardant fillers (e.g., aluminum hydroxide or intumescent additives).

The construction board assembly 10 includes a first side 26 defined by the first face 18 of the construction board 12 and a second side 28 defined by the second face 24 of the acoustic textile board 14. The first side 26 and the second side 28 are uncovered. For example, the uncovered sides are free from paper or additional layers/coverings, and the material (MgO) for the construction board 12 and the textile material for the acoustic textile board 14 is exposed.

The construction board assembly 10 is transportable and able to be installed as a single unit. For example, the construction board 12 and the acoustic textile board 14 are laminated across their entire interface to define a monolithic flexural profile when transported as a single unit and when installed. When joined, the construction board 12, the acoustic textile board 14, and the adhesive 16 form a monolithic flexural profile. As used herein, 'monolithic flexural profile' means that under bending stresses, the layers exhibit continuous composite action without internal slip or delamination at the adhesive interface. The rigid magnesium oxide construction board 12 carries tensile and compressive bending forces, while the continuous, high-shear-strength adhesive layer 16 fully transfers horizontal shear stresses between the construction board 12 and the acoustic textile board 14, causing the multi-layer assembly to behave mechanically as a single, unified structural member.

When transported as a single unit under its own self-weight or installed, the construction board assembly 10 maintains a maximum deflection of less than L/360, where L represents the span length of the construction board assembly 10. The maximum deflection of less than L/360 is determined under standard design loads (e.g., self-weight plus applicable live loads) as measured at the center of the span, ensuring that the construction board assembly 10 maintains structural rigidity sufficient to prevent cracking, bending, or delamination of the construction board assembly 10.

Also, the adhesive 16 provides a peel strength sufficient to maintain the monolithic arrangement when fasteners are driven through the construction board 12 and/or the acoustic textile board 14 into structural framing members. The peel strength of the construction board assembly 10 refers to a measure of the force required to separate the construction board 12 from the acoustic textile board 14, or vice versa, by peeling one layer away from the other. The peel strength indicates bond quality between the construction board 12 and the acoustic textile board 14 and directly affects the structural integrity and durability of the assembly. For example, the peel strength is determined by the type and amount of the adhesive 16, as well as the surface preparation and bonding conditions. A higher peel strength indicates a stronger bond between the construction board 12 and the acoustic textile board 14, which facilitates withstanding various environmental and mechanical stresses, such as temperature fluctuations, humidity, and mechanical loads. The peel strength is measured in units of force per unit width, such as pounds per inch or Newtons per meter (N/m), and can be evaluated using standardized test methods, such as the ASTM D3167 or ISO 8510-1 standards. In some examples, the construction board assembly 10 has a minimum peel strength of 10 pounds per inch (17.8 N/m), which indicates adequate bonding and structural performance of the construction board assembly 10.

Also, the construction board assembly 10 is reversible because the construction board assembly 10 is configured to attach to structural framing members with the first (uncovered) side 26 or the second (uncovered) side 28 facing the structural framing members. Both the construction board 12 and the acoustic textile board 14 are configured to receive and retain a finish material fastener or sit flush against a framing member, depending on the orientation of the construction board assembly 10. Specifically, when the second side 28 faces the structural framing members, the acoustic textile board 14 can receive and retain a finish material fastener, and the construction board 12 can sit flush against a framing member. When the first side 26 faces the structural framing members, the construction board 12 can receive and retain a finish material fastener, and the acoustic textile board 14 can sit flush against a framing member. This reversibility is made possible at least in part by the flat nature of the first side 26 and the second side 28. For example, the first side 26 and the second side 28 are flat, and either side is configured to attach to a framing member.

As illustrated in FIGS. 1-3, the construction board 12, the acoustic textile board 14, and the adhesive 16 are arranged to emphasize the structural and insulative properties of the construction board assembly 10 and contribute to the effectiveness of the construction board assembly 10 in reducing sound transmission and/or thermal bridging. For example, the different materials are seamlessly integrated into a single composite structure that cannot be separated without damaging the materials. This facilitates the effectiveness of the construction board assembly 10 in reducing thermal bridging and sound transmission, simplifying construction, and enhancing energy efficiency.

As described above, the construction board assembly 10 is transportable as a single unit and is reversible (e.g., configured to attach to structural framing members with the first uncovered side or the second uncovered side facing the structural framing members). Moreover, the construction board assembly 10 is preassembled (i.e., assembled at a location away from an installation site) in a modular state that can be transported and installed without modification or additional assembly.

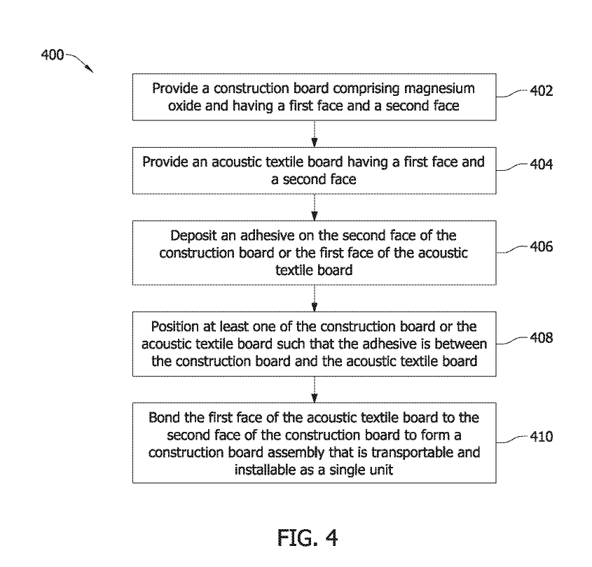

FIG. 4 is a flow diagram of a method 400 of assembling the construction board assembly 10 shown in FIGS. 1-3. Referring to FIGS. 1-4, the method 400 includes providing 402 a construction board (e.g., the construction board 12) and providing 404 an acoustic textile board (e.g., the acoustic textile board 14) including a first face and a second face. In addition, the construction board and/or the acoustic textile board may be prepared by, for example, cutting the construction board and/or the acoustic textile board to the desired dimensions from sheets and cleaning the cut boards. The faces of the construction board and/or the acoustic textile board are treated to ensure the surfaces are smooth and free from contaminants for adhesion. Suitably, the construction board and/or the acoustic textile board are the same shape and size such that the boards align with each other when placed in face-to-face engagement.

The method 400 further includes depositing 406 an adhesive (e.g., the adhesive 16) on at least one of the second face of the construction board or the first face of the acoustic textile board. The adhesive may be deposited manually and/or at least partly automatically. The adhesive may be a liquid adhesive that is deposited in a liquid form and then set or cured to form a bond between the construction board and the acoustic textile board. The adhesive is applied to laminate the construction board and the acoustic textile board across their entire interface and form a monolithic flexural profile that maintains a maximum deflection of less than L/360 when transported as a single unit. In some examples, at least one additive selected to modify a property of the adhesive is distributed within the adhesive prior to curing or setting of the liquid adhesive.

In some examples, the adhesive is deposited such that the adhesive forms a continuous and monolithic layer extending throughout the entire interface between the construction board and the acoustic textile board. The adhesive is deposited in a manner to facilitate precise application and integration of the adhesive and improve the performance characteristics of the construction board assembly. For example, a polymeric adhesive such as an epoxy resin or a one-part moisture-cure urethane adhesive is applied to the first face of the acoustic textile board using roll coater equipment for even distribution. For example, the structural urethane adhesive is applied onto the surface of the acoustic textile board at 12-14 grams per square foot (129-150 grams per square meter) or 2 grams per square foot (22 grams per square meter). In some examples, the adhesive is deposited utilizing a 3D printing device or a pattern deposition mechanism for low-cost manufacture.

After the adhesive is applied, at least one of the construction board or the acoustic textile board is positioned 408 such that the adhesive is between the construction board and the acoustic textile board. For example, the construction board is moved relative to and applied to the adhesive-coated side of the acoustic textile board, ensuring the edges of the boards are aligned. The construction board and the acoustic textile board are positioned together with the adhesive between the construction board and the acoustic textile board such that the adhesive bonds the first face of the acoustic textile board to the second face of the construction board to form the construction board assembly.

After positioning the construction board relative to the acoustic textile board, in some examples, the method includes a quality control step of verifying the precise alignment of the lateral surfaces of both boards to ensure a flush, modular fit during installation. The construction board and/or the acoustic textile board may be shifted to align the lateral surfaces of the boards and provide planar lateral surfaces of the construction board assembly. Following alignment, the construction board and the acoustic textile board are stacked and moved to a mechanical press where a desired pressure is applied to maintain and press the construction board and the acoustic textile board together. The assembly is maintained under constant compression within the mechanical press to ensure full polymerization of the structural adhesive 16 and to eliminate voids at the interface.

In some examples, the construction board assembly is subjected to a controlled curing process, where the construction board assembly is heated to a curing temperature of the adhesive, for example between 150°C to 200°C, to achieve maximum strength and thermal stability. Uniform pressure is applied, via for example the mechanical press, during curing to enhance bonding and ensure a void-free structure. The curing process is carried out for a manufacturer-recommended time to achieve full polymerization. For example, the adhesive is cured or set under the controlled pressure (e.g., pressure with a range of 50 to 100 psi) for a minimum of 3-5 minutes to 10-15 minutes or more, depending on the specific adhesive and environmental conditions such as temperature and humidity. This cycle ensures full polymerization of a specialized structural low-VOC adhesive and eliminates microscopic voids at the interface to form a monolithic flexural profile with a minimum peel strength of, for example, 10 pounds per inch.

After curing, the construction board assembly may undergo post-curing treatment to further enhance properties of the construction board assembly. In some examples, the construction board assembly is heat-treated (e.g., exposed to a heating source for a predetermined time) to improve the epoxy’s fire resistance and acoustic properties.

When complete, the adhesive bonds 410 the first face of the acoustic textile board to the second face of the construction board to form the construction board assembly that is transportable and installable as a single unit. The completed construction board assemblies are inspected for quality and palletized for shipping. A label or stamp may be added for identification.

After assembly, the construction board assembly is configured to be used in structures. The construction board assembly may be installed as a sheathing and attached to structural framing members with the first side or the second side facing the structural framing members. When installed as sheathing, the construction board assembly has a structural load capacity to resist forces and provides structural support for a wall, floor, or other component of a building or other structure. In addition, the construction board and the acoustic textile board of the construction board assembly are configured to receive and retain a finish material fastener or to sit flush against a framing member.

Suitably, the construction board assembly 10 is customizable to provide different characteristics. For example, additional material may be added between, on, or incorporated into the construction board 12, the acoustic textile board 14, and/or the adhesive 16 to provide a desired characteristic. In some examples, the construction board assembly 10 includes a built-in weather-resistant barrier (WRB) and/or a bulletproof material that is incorporated in at least one of the following locations: (1) into the construction board 12 or the acoustic textile board 14, (2) between the construction board 12 and the acoustic textile board 14, (3) into the adhesive 16, or (4) on one or both of the outer surfaces of the construction board assembly 10. In some examples, surface coatings are applied to the construction board 12 and/or the acoustic textile board 14 to enhance durability, aesthetics, and/or other properties.

In addition, the thickness of the construction board and/or the acoustic textile board may be adjusted to provide improved strength (e.g., thicker construction board) or improved insulating properties (thicker insulation). Alternatively or additionally, additional boards may be added to increase the thickness. Moreover, additives may be added to the construction board and/or the acoustic textile board during formation of the respective board(s) to provide or enhance desired properties.

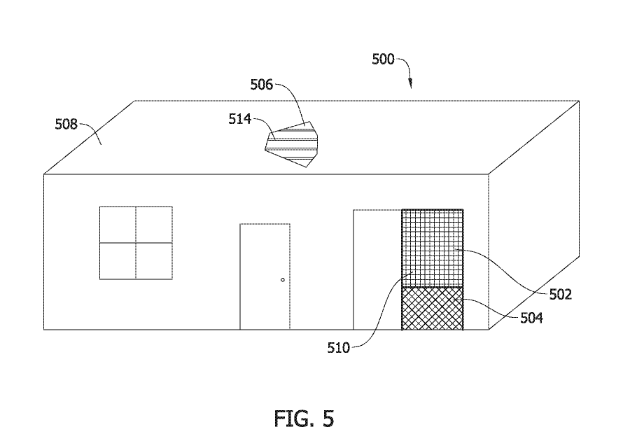

FIG. 5 illustrates a structure, e.g., a building, 500. The structure 500 includes components such as walls 502, floors 504, ceilings 506, and a roof 508. Portions of the structure 500 have been omitted to better illustrate the described components. For example, a portion of the roof 508 is omitted to reveal the structural framing members 514 and the ceiling 506.

Referring to FIGS. 1-3 and 5, the construction board assembly 10 shown in FIGS. 1-3 may be used in any components of the structure 500 shown in FIG. 5 to provide improved performance and simplify assembly of the structure 500. For example, the construction board assembly 10 may be used in the walls 502, the floors 504, the ceilings 506, and the roof 508. The construction board assembly 10 is directly mounted to the structural framing members 514 and may receive a finish material 510 or provide a finished surface for any of the walls 502, the floors 504, the ceilings 506, and the roof 508. The finish material 510 may include exterior or interior cladding (e.g., tile, brick or stone veneer, siding, wallpaper, and paint) or flooring materials (e.g., tile, hardwood, carpet, laminate, and luxury vinyl tile (LVT)).

The construction board assembly 10 simplifies assembly of the structure 500 because the construction board assembly 10 is modular and includes multiple materials in a single unit. The construction board assembly 10 is simple to install and provides improved performance over other systems. Moreover, the construction board assembly 10 may be installed in different orientations based on the application or desired properties. For example, the construction board assembly 10 may be installed to present the construction board 12 as a finished surface when impact or wear resistance is required for the walls 502, the floors 504, the ceilings 506, or the roof 508. Alternatively, the construction board assembly 10 may be installed with the acoustic textile board 14 facing outward when appropriate for the application.

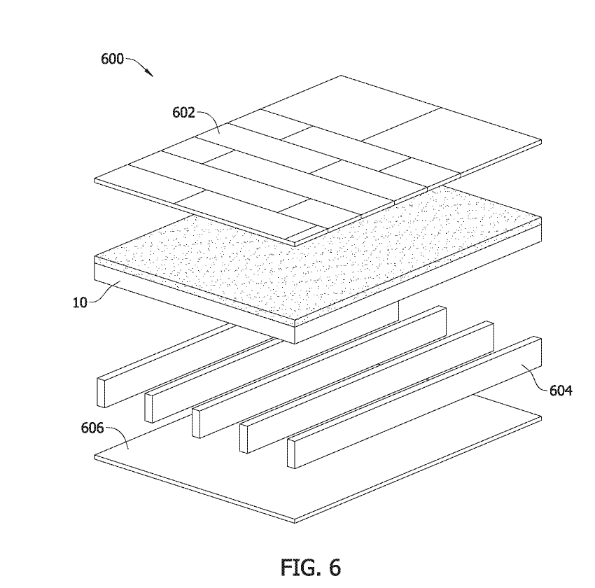

FIG. 6 illustrates an exploded view of an example of a floor 600, including the construction board assembly 10. The construction board assembly 10 is incorporated into the floor 600 to provide improved performance capabilities and facilitate simple and quick construction of the floor 600. For example, the construction board assembly 10, in a first configuration, forms a combination sheathing and subfloor that sits between finish material 602 and structural framing members 604. The construction board assembly 10 provides insulative and sound-dampening properties for the floor and, in addition, provides structural support to the floor 600.

A ceiling 606 is secured to the underside of the structural framing members 604 opposite the construction board assembly 10 and defines a finished space below the floor 600, which may be a livable area. The characteristics of the construction board assembly 10 dampen sound transmission through the floor 600 between the livable spaces while providing a low profile for the floor 600 such that the floor 600 occupies less space available for the livable spaces (i.e., the low profile of the floor facilitates the livable space having a higher ceiling height). In addition, the construction board assembly 10 forms a fire, pest, and/or moisture barrier between the livable spaces to reduce moisture intrusion, pest or rodent movement between the spaces, and fire spreading between the spaces.

The construction board assembly 10 provides a mounting surface for the finish material 602. In the example, the finish material 602 may be any suitable flooring material (e.g., tile, hardwood, carpet, laminate, and luxury vinyl tile (LVT)) and is directly applied and attached to the construction board assembly 10. The construction board assembly 10 fully supports the finish material 602. In addition, the construction board assembly 10 provides a continuous insulative break because fasteners do not need to extend through the entire construction board assembly 10 to be supported, and the acoustic textile board 14 provides a continuous insulation that increases the thermal resistance value and lowers sound transmittance through the floor 600.

In the example illustrated in FIG. 6, the construction board assembly 10 directly receives the finish material 602. In some examples, the finish material 602 is omitted, and the construction board assembly 10 acts as a direct finish exterior material because of the properties of the construction board assembly 10. In such an example, the construction board assembly 10 is secured in a second configuration in which the acoustical textile board 14 of the construction board assembly 10 faces the structural framing members 604 and the construction board 12 provides the finish surface.

The construction board assembly 10 is directly attached to the structural framing members 604. Suitably, the construction board assembly 10 is reversible, and both a first side and a second side of the construction board assembly 10 are arranged to mount to the structural framing members 604. For example, both sides of the construction board assembly 10 are flat and continuous, and either side is configured to sit flush against the structural framing members when the construction board assembly is attached to the structural framing members. In addition, both sides of the construction board assembly are configured to receive and retain a finish material fastener when the side faces away from the structural framing members 604. In the example, the construction board 12 of the construction board assembly 10 faces and is secured directly to the structural framing members 604.

The adhesive joins the construction board assembly 10 together with sufficient structural force for the construction board assembly 10 to act as a single structural member and resist delamination when forces are applied to individual layers. For example, the adhesive maintains the union of the construction board assembly 10 and resists delamination when fasteners are driven through the construction board 12 and/or the acoustic textile board 14 from either side to secure the construction board assembly to the structural framing members 604 or the finish material 602.

The construction board assembly 10 is directly attached to the structural framing members 604 and is compatible with different material types. For example, the structural framing members 604 may be wood, light-gauge steel, and/or any suitable structural framing. The structural framing members 604 may define openings or conduits for utility services (e.g., pipes and wires).

In the example, the floor 600 is free of insulation between the structural framing members 604 or elsewhere within the floor, and the floor 600 still provides improved sound-dampening performance because of the materials of the construction board assembly 10. In addition, the construction board assembly 10 provides improved fire and pest resistance. In some examples, additional sound or thermal insulation may be added to the floor 600 to provide even further improved performance.

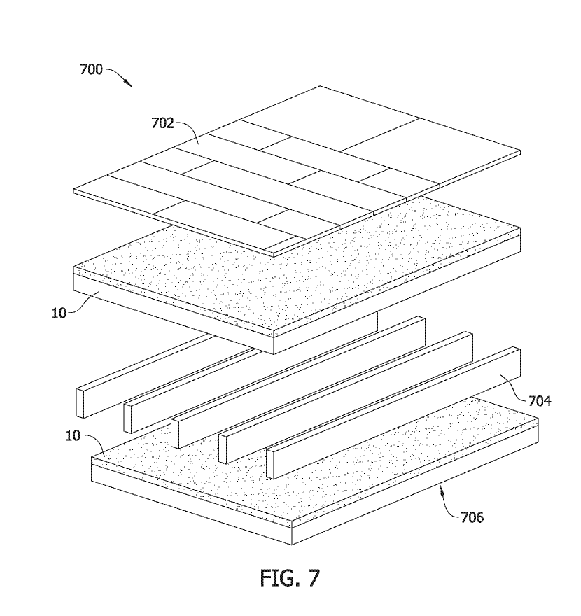

FIG. 7 illustrates an exploded view of an example of a floor 700, including the construction board assembly 10. For example, the construction board assembly 10, in a first configuration, forms a combination sheathing and subfloor that sits between finish material 702 and structural framing members 704. Also, the construction board assembly 10, in a second configuration, forms a ceiling 706 below the structural framing members 704.

The construction board assembly 10 may simplify construction because the construction board assembly 10 provides multiple materials having complementary and enhanced properties in a single assembly. For example, the construction board assembly 10 provides increased sound insulation and performance characteristics to the floor 700 and provides improved insulation and strength to the ceiling 706 because of the properties of the construction board assembly 10. Also, the construction board assembly 10 is configured to receive finish material or provide a direct finished surface for the ceiling 706. Suitably, the construction board assembly 10 forming the ceiling 706 directly receives a finish material (e.g., veneer, paint, or wallpaper) or may be left exposed.

The construction board assembly 10 is configured for use in multiple locations in the floor 700 and simplifies the number of different materials for the construction of the floor. In addition, the construction board assembly 10 does not need special installation instructions for installation in either orientation or configuration because the construction board assembly 10 is configured to receive standard fasteners and be installed in any orientation. Accordingly, the construction board assembly 10 simplifies construction of the structure and may reduce labor and material costs for construction.

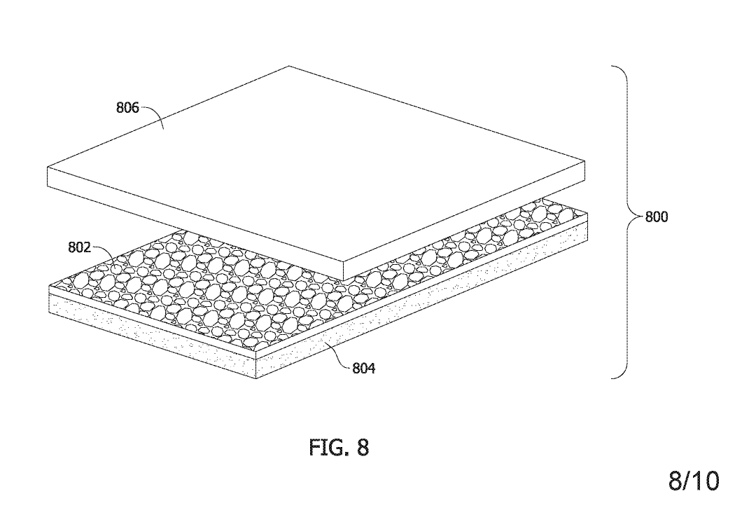

FIG. 8 is an exploded perspective view of an example of a construction board assembly 800 including adhesive 802 deposited in a unique arrangement. The construction board assembly 800 is similar to the construction board assembly 10 shown in FIGS. 1-3, except the construction board assembly 800 includes the adhesive 802 deposited onto a surface of an acoustic textile board 804 and/or a construction board 806 in a pattern selected to maximize bonding while saving on material and labor costs and/or to otherwise improve performance characteristics of the construction board assembly 800.

The adhesive 802 may be deposited in a pattern selected to facilitate reducing sound transmission between layers of the construction board assembly 800. For example, the adhesive 802 as shown in FIG. 8 is deposited in a random pattern. In other examples, the adhesive 802 may be deposited in a symmetrical or repeating pattern such as a series of geometric shapes. In one example, the adhesive 802 is deposited in a pattern including repeating hexagons in which the hexagonal structure disrupts and scatters sound waves. For example, a cell size and wall thickness of the geometric shapes may be customized based on the desired acoustic and strength performance, while maintaining a uniform thickness for consistent load distribution.

The adhesive 802 may be any suitable adhesive. For example, the adhesive may include a polymeric adhesive, which may include one or more of a urethane adhesive (e.g., a one-part moisture-cure urethane), an epoxy resin, an acrylic adhesive, a cyanoacrylate, a silicone, a polyvinyl acetate (PVA), or an ethylene-vinyl acetate (EVA). In other examples, the adhesive 802 may include a non-polymeric adhesive, such as a modified silane (MS) polymer, a cementitious adhesive, or an inorganic adhesive like sodium silicate.

The adhesive 802 may be manually and/or at least partly automatically deposited in any suitable manner. For example, the adhesive 802 may be sprayed, rolled, dropped, and/or dripped onto the surface. Alternatively, the adhesive 802 may be printed and/or extruded onto the surface. The adhesive 802 may be deposited in a liquid, molten, or semi-solid form and subsequently set or cured to form a permanent bond.

In some examples, the adhesive 802 is formed as a geometric core using a specialized deposition method, such as precision 3D printing or automated extrusion. An example that may be applied in such a manner is a novolac-based epoxy resin. During assembly of the construction board assembly 800, the epoxy resin may be partially cured to achieve a semi-rigid state before bonding the components of the construction board assembly 800. The semi-rigid state of the adhesive 802 facilitates the adhesive 802 maintaining its shape during subsequent bonding of the acoustic textile board 804 to the construction board 806.

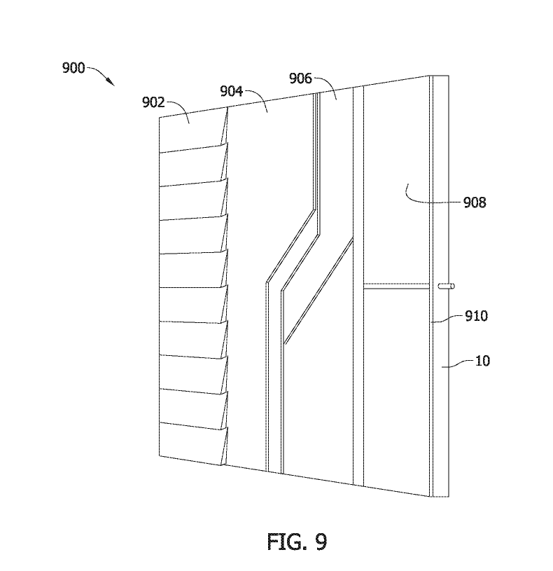

FIG. 9 illustrates an exploded view of an example of an exterior wall 900, including the construction board assembly 10, with portions removed to illustrate interior components. The exterior wall 900 includes exterior cladding 902, exterior sheathing 904, thermal insulation (e.g., closed-cell spray foam insulation) 906, optional acoustic insulation 908, structural framing members (e.g., light gauge steel framing members) 910, and the construction board assembly 10.

For example, the construction board assembly 10, in a first configuration, forms a combination sheathing and sound barrier on an interior of the structure. The construction board assembly 10 is attached directly to the structural framing members 910.

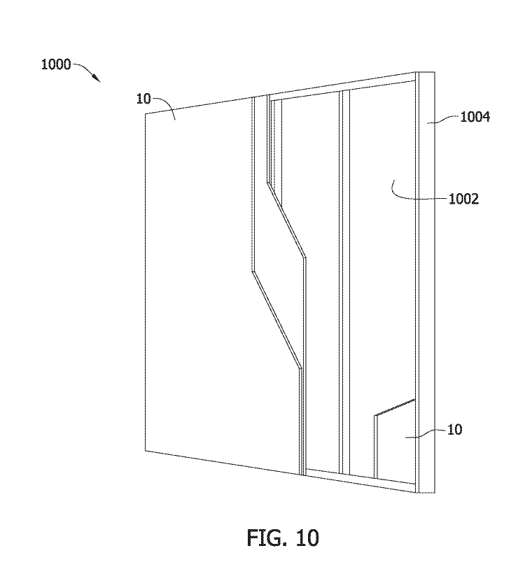

FIG. 10 illustrates an exploded view of an example of an interior wall 1000, including the construction board assembly 10, with portions removed to illustrate interior components. The interior wall 1000 includes the construction board assembly 10, optional acoustic insulation 1002, and structural framing members (e.g., cold-formed steel framing members) 1004. In the example, the construction board assembly 10 forms two sides of the interior wall 1000 and the structural framing members 1004 are sandwiched between the construction board assemblies 10. The construction board assembly 10 is attached directly to the structural framing members 1004 on both sides.

As illustrated in FIGS. 9 and FIG. 10, the construction board assembly 10 is configured for direct attachment to structural framing members 910, 1004, such as cold-formed steel or wood studs, in use in walls (or other components of a building). In wall applications, the integration of the MgO board and the acoustic textile board serves as a continuous acoustic break and significantly reduces sound transmission class (STC) ratings without the need for additional isolation clips or resilient channels. For example, according to standardized acoustic testing, the construction board assembly 10 achieves a STC rating and an impact insulation class (IIC) rating that exceed those of standard gypsum-on-stud configurations by at least 15-20%. These ratings are achieved through, for example, the synergistic effect of the magnesium oxide construction board 12 and the porous matrix of the acoustic textile board 14, which dissipates sound energy through viscous friction within the interstitial channels 15.

### Numbered Examples

Example 1. A construction board assembly comprising: a construction board comprising magnesium oxide and including a first face and a second face, wherein the first face of the construction board defines a first side of the construction board assembly; an acoustic textile board including a first face and a second face, wherein the second face of the acoustic textile board defines a second side of the construction board assembly; and an adhesive between the construction board and the acoustic textile board, wherein the adhesive bonds the first face of the acoustic textile board to the second face of the construction board, wherein the construction board assembly is transportable as a single unit and is configured to attach to structural framing members with the first side or the second side facing the structural framing members.

Example 2. A construction board assembly in accordance with example 1, wherein the acoustic textile board includes fibers selected for performance properties including at least one of acoustical properties, structural strength, fire resistance, thermal conductivity, moisture or air intrusion, or insect protection.

Example 3. A construction board assembly in accordance with example 2, wherein the fibers include recycled denim.

Example 4. A construction board assembly in accordance with example 1, wherein the adhesive forms a continuous and monolithic layer extending throughout an entire interface between the construction board and the acoustic textile board.

Example 5. A construction board assembly in accordance with example 1, wherein the adhesive includes a polymeric adhesive.

Example 6. A construction board assembly in accordance with example 5, wherein the adhesive includes at least one additive selected to modify a property of the polymeric adhesive, wherein the at least one additive is distributed within the polymeric adhesive prior to curing or setting of the polymeric adhesive.

Example 7. A construction board assembly in accordance with example 1, wherein the construction board and the acoustic textile board are laminated across their entire interface to define a monolithic flexural profile.

Example 8. A construction board assembly in accordance with example 7, wherein the construction board has a density greater than 0.9 g/cm³, and wherein the construction board assembly has a structural load capacity to resist forces and provide structural support for a wall or floor of a building.

Example 9. A method of assembling a construction board assembly, the method comprising: providing a construction board comprising magnesium oxide and including a first face and a second face, wherein the first face of the construction board defines a first side of the construction board assembly; providing an acoustic textile board including a first face and a second face, wherein the second face of the acoustic textile board defines a second side of the construction board assembly; and depositing an adhesive on the second face of the construction board or the first face of the acoustic textile board, wherein the adhesive bonds the first face of the acoustic textile board to the second face of the construction board to form the construction board assembly.

Example 10. A method in accordance with example 9, further comprising depositing the adhesive in a continuous and monolithic layer between the construction board and the acoustic textile board such that the adhesive extends throughout an entire interface between the construction board and the acoustic textile board.

Example 11. A method in accordance with example 9, wherein the adhesive includes a polymeric adhesive, and further comprising curing or setting the polymeric adhesive.

Example 12. A method in accordance with example 11, further comprising distributing at least one additive within the polymeric adhesive prior to curing or setting of the polymeric adhesive.

Example 13. A method in accordance with example 9, further comprising attaching the construction board assembly to structural framing members with the second face of the acoustic textile board facing the structural framing members and the construction board arranged to receive and retain a finish material fastener.

Example 14. A method in accordance with example 9, further comprising installing the construction board assembly as a sheathing in a wall or floor of a building, wherein the construction board assembly has a structural load capacity selected to resist forces and provide structural support for the wall or floor of the building.

Example 15. A method in accordance with example 9, further comprising laminating the construction board and the acoustic textile board across an entire interface between the construction board and the acoustic textile board to define a monolithic flexural profile.

Example 16. A method in accordance with example 15, further comprising pressing the construction board and the acoustic textile board together until the adhesive cures to provide a peel strength sufficient to maintain the monolithic flexural profile when fasteners are driven through the construction board or the acoustic textile board.

Example 17. A structure comprising: structural framing members; and a construction board assembly attached to the structural framing members, wherein the construction board assembly comprises: a construction board comprising magnesium oxide and including a first face and a second face; an acoustic textile board including a first face and a second face; and an adhesive between the construction board and the acoustic textile board, wherein the adhesive bonds the first face of the acoustic textile board to the second face of the construction board, wherein the first face of the construction board or the second face of the acoustic textile board is mounted to the structural framing members.

Example 18. A structure in accordance with example 17, further comprising a floor, wherein the construction board assembly forms sheathing that supports the floor.

Example 19. A structure in accordance with example 17, wherein the adhesive includes a polymeric adhesive that forms a continuous and monolithic layer extending throughout an entire interface between the construction board and the acoustic textile board.

Example 20. A structure in accordance with example 17, further comprising a finish material attached to the first face of the construction board, wherein the construction board assembly is attached to the structural framing members with the second face of the acoustic textile board facing the structural framing members.

The construction board assembly offers numerous benefits, including lightweight strength that provides a balance of structural strength and low weight, making it ideal for soundproof structures that must maintain mechanical integrity. Additionally, the assembly's design provides an additional benefit of thermal insulation. Example features and benefits of the construction board assembly include acoustic deadening, minimizing transmission, and acoustic damping agents in the epoxy that enhance soundproofing qualities, especially for low- and mid-frequency sounds. The assembly also provides increased strength, with bonding to fiber-reinforced cement board further enhancing structural integrity. Furthermore, the construction board assembly offers enhanced fire resistance, making it a highly desirable solution for various construction applications.

When introducing elements of the present disclosure or the preferred embodiment(s) thereof, the articles "a", "an", "the" and "said" are intended to mean that there are one or more of the elements. The terms "comprising", "including" and "having" are intended to be inclusive and mean that there may be additional elements other than the listed elements.

As various changes could be made in the above constructions without departing from the scope of the disclosure, it is intended that all matter contained in the above description and shown in the accompanying drawings shall be interpreted as illustrative and not in a limiting sense. Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. Regardless of whether shown and described in combination or separately, the various features (both structural and methodological) are intended to be selectively included or omitted to produce an embodiment with a particular set of features. In addition, each of the operations described above may be executed in any order. For example, one operation may be performed before another operation. Additionally, one or more of the disclosed operations may be performed simultaneously or substantially simultaneously.

What is claimed is:

1. A construction board assembly comprising:
a construction board comprising magnesium oxide and including a first face and a second face, wherein the first face of the construction board defines a first side of the construction board assembly;
an acoustic textile board including a first face and a second face, wherein the second face of the acoustic textile board defines a second side of the construction board assembly; and
an adhesive between the construction board and the acoustic textile board, wherein the adhesive bonds the first face of the acoustic textile board to the second face of the construction board,
wherein the construction board assembly is transportable as a single unit and is configured to attach to structural framing members with the first side or the second side facing the structural framing members.

2. A construction board assembly in accordance with claim 1, wherein the acoustic textile board includes fibers selected for performance properties including at least one of acoustical properties, structural strength, fire resistance, thermal conductivity, moisture or air intrusion, or insect protection.

3. A construction board assembly in accordance with claim 2, wherein the fibers include recycled denim.

4. A construction board assembly in accordance with claim 1, wherein the adhesive forms a continuous and monolithic layer extending throughout an entire interface between the construction board and the acoustic textile board.

5. A construction board assembly in accordance with claim 1, wherein the adhesive includes a polymeric adhesive.

6. A construction board assembly in accordance with claim 5, wherein the adhesive includes at least one additive selected to modify a property of the polymeric adhesive, wherein the at least one additive is distributed within the polymeric adhesive prior to curing or setting of the polymeric adhesive.

7. A construction board assembly in accordance with claim 1, wherein the construction board and the acoustic textile board are laminated across their entire interface to define a monolithic flexural profile.

8. A construction board assembly in accordance with claim 7, wherein the construction board has a density greater than 0.9 g/cm³, and wherein the construction board assembly has a structural load capacity to resist forces and provide structural support for a wall or floor of a building.

9. A method of assembling a construction board assembly, the method comprising:
providing a construction board comprising magnesium oxide and including a first face and a second face, wherein the first face of the construction board defines a first side of the construction board assembly;
providing an acoustic textile board including a first face and a second face, wherein the second face of the acoustic textile board defines a second side of the construction board assembly; and
depositing an adhesive on the second face of the construction board or the first face of the acoustic textile board, wherein the adhesive bonds the first face of the acoustic textile board to the second face of the construction board to form the construction board assembly.

10. A method in accordance with claim 9, further comprising depositing the adhesive in a continuous and monolithic layer between the construction board and the acoustic textile board such that the adhesive extends throughout an entire interface between the construction board and the acoustic textile board.

11. A method in accordance with claim 9, wherein the adhesive includes a polymeric adhesive, and further comprising curing or setting the polymeric adhesive.

12. A method in accordance with claim 11, further comprising distributing at least one additive within the polymeric adhesive prior to curing or setting of the polymeric adhesive.

13. A method in accordance with claim 9, further comprising attaching the construction board assembly to structural framing members with the second face of the acoustic textile board facing the structural framing members and the construction board arranged to receive and retain a finish material fastener.

14. A method in accordance with claim 9, further comprising installing the construction board assembly as a sheathing in a wall or floor of a building, wherein the construction board assembly has a structural load capacity selected to resist forces and provide structural support for the wall or floor of the building.

15. A method in accordance with claim 9, further comprising laminating the construction board and the acoustic textile board across an entire interface between the construction board and the acoustic textile board to define a monolithic flexural profile.

16. A method in accordance with claim 15, further comprising pressing the construction board and the acoustic textile board together until the adhesive cures to provide a peel strength sufficient to maintain the monolithic flexural profile when fasteners are driven through the construction board or the acoustic textile board.

17. A structure comprising:
structural framing members; and
a construction board assembly attached to the structural framing members, wherein the construction board assembly comprises:
a construction board comprising magnesium oxide and including a first face and a second face;
an acoustic textile board including a first face and a second face; and
an adhesive between the construction board and the acoustic textile board, wherein the adhesive bonds the first face of the acoustic textile board to the second face of the construction board,
wherein the first face of the construction board or the second face of the acoustic textile board is mounted to the structural framing members.

18. A structure in accordance with claim 17, further comprising a floor, wherein the construction board assembly forms sheathing that supports the floor.

19. A structure in accordance with claim 17, wherein the adhesive includes a polymeric adhesive that forms a continuous and monolithic layer extending throughout an entire interface between the construction board and the acoustic textile board.

20. A structure in accordance with claim 17, further comprising a finish material attached to the first face of the construction board, wherein the construction board assembly is attached to the structural framing members with the second face of the acoustic textile board facing the structural framing members.
